(19) United States
(12) Patent Application Publication
(10) Pub. No.: US 2005/0276950 A1
(43) Pub. Date: Dec. 15, 2005

(54) Floor structure

(76) Inventor: Dany Marquette, Boucherville (CA)

Correspondence Address: Eric Fincham, 316 Knowlton Road, Lac Brome, QC, J0E 1V0, CA

(21) Appl. No.: 11/103,083

(22) Filed: Apr. 11, 2005

(30) Foreign Application Priority Data
Jun. 9, 2004 (CA) 2,470,538

(51) Int. Cl. B32B 3/14

(52) U.S. Cl. 428/156

(57) ABSTRACT

A flooring product for use in a vehicle such as a truck, the flooring product having an upper layer and a lower layer, the upper layer being formed of at least first and second portions each of rubber fragments bonded together, the first portion and the second portion each having a different hardness measurement.

### FIELD OF THE INVENTION

The present invention relates to vehicles and more particularly, relates to a floor structure useful for vehicles such as trucks and trailers having a cargo carrying capacity.

### BACKGROUND OF THE INVENTION

The floor structure of vehicles designed to carry cargo will vary depending upon the end use thereof and the cargo which is to be transported. Generally, the vehicle will include structural components forming a portion of a frame structure and which is designed to carry or support a floor. The floor is conventionally formed of a metallic or wood material which is supported by the structural components. It is also known in the art to use various types of plastic and it is also known to provide inserts or liners which will sit on the original floor provided by the manufacturer of the vehicle.

As aforementioned, the particular floor can vary depending upon the cargo which will be carried. However, problems which are universally encountered include damage which can occur to the floor from impact. In the case of vehicles having a wood floor, the wood frequently breaks and must be replaced. Even with metallic floors, an impact can deform and even fracture the metal thereby necessitating replacement.

A further problem associated with conventional floors is that although the cargo is usually secured in place by means of various types of straps, any slight loosening of the straps will mean that the cargo is able to move and breakage or damage to the goods can occur.

A further problem which is not directly related to the above, is that of the disposing of or recycling used vehicle tires. These tires fill up disposal areas in garbage dumps and indeed, many end up littering the landscape. One very large problem is the possibility of fires which can occur in tire dumps. These fires are very difficult to put out and can cause substantial pollution of the water table during their attempts to do so.

There have been many uses which have been found for reusing the material in discarded tires including using the material for manufacture of various types of mats and landscaping devices. Thus, it has been proposed to use the material in railroad as landscaping ties, loading dock bumpers, and the like. The use of rubber fragments in manufacturing products is well known and thus, one may refer to U.S. Pat. No. 4,343,669 issued Aug. 10, 1992 to J. C. Prior which teaches a method of making a building component wherein shredded waste material forms an inner core and a sheet material provides a casing.

U.S. Pat. No. 4,109,041 issued Aug. 22, 1978 to Tellman teaches the use of rubber fragments in conjunction with a construction panel. The rubber is utilized as a coating for particle board in order to increase the surface friction of the board.

U.S. Pat. No. 5,238,734 issued Aug. 14, 1933 to Murray teaches the use of rubber fragments to make railroad ties. The fragments are mixed with an epoxy material.

U.S. Pat. No. 5,316,708 issued May 31, 1994 to Drews discloses a method of making building blocks wherein the shredded material is mixed with latex, compressed and cured.

U.S. Pat. No. 5,439,735 issued Aug. 8, 1995 to Jamison teaches using scrap rubber and textile material to create particle board products having desired thermal and acoustical installation property. U.S. Pat. 5,704,178 issued Jan. 6, 1998 teaches the use of rubber fragments in building panels which are designed for use in house construction. The rubber panel comprises metal frame members having a metal mesh on the interior and rubber fragments on the exterior thereof.

### SUMMARY OF THE INVENTION

It is an object of the present invention to provide a flooring product which is suitable for use on the floor of a cargo transporting vehicle and which flooring product is resistant to damage while providing other desirable physical characteristics.

It is a further object of the present invention to provide a flooring product which uses recycled rubber fragments.

According to one aspect of the present invention, there is provided a flooring product suitable for use on a vehicle, the flooring product comprising a base formed of a load bearing material, an upper layer formed of rubber fragments bonded together, the upper layer being secured to the base, the upper layer being formed of at least a first portion and a second portion, the first portion and the second portion each having a different hardness measurement.

According to a further aspect of the present invention, in a vehicle having a floor for receiving cargo, and wherein the floor is supported by structural members, the improvement wherein the floor comprises a lower layer and an upper layer, the lower layer being formed of a load bearing material selected from the group consisting of wood materials and metallic materials, the upper layer being adhesively secured to the lower layer, the upper layer being formed of rubber fragments bonded together.

As used herein, a vehicle is generally utilized to designate a cargo carrying vehicle. The vehicle may be a truck having a cargo carrying floor. It is also intended to include trailers such as those forming a portion of a tractor trailer unit.

The term rubber fragment, as utilized herein, will generally include both natural and synthetic rubbers and other suitable elastomeric materials having the desired physical properties.

The vehicle will have a structure wherein there is provided a frame and which frame will usually include longitudinally extending frame members as well as transversely extending frame members. The floor is placed on top of these frame members and is suitably secured thereto.

The lower layer, as previously mentioned, may either be formed of a metallic or a wood material. In the case of a metallic material, aluminum is conventionally used although other metals and/or alloys thereof may be employed.

In the instance wherein wood is employed, it is generally a composite manufactured wood product and which would typically have a thickness of between 15 and 30 mm. The composite wood product would normally consist of layers of a product such as oriented strand board or plywood. Preferably, the underside is treated with a material to prevent moisture penetration therethrough and to this end, materials such as a fiberglass coating may be employed.

The upper layer, as previously mentioned, includes two different portions. In this regard, the outer portion may be formed of a rubber material which has a different hardness measurement compared to the hardness of the central portion. The outer portion is slightly softer or more compressible such that a greater load stability is achieved. Typically, the outer portion will have a hardness reading of between A65 to A75 as measured on a Shore Hardness Meter under ASTM D-2240, while the central portion will have a hardness reading of between A76 to A90. The specific gravity is preferably between 1.12 and 1.16. In a preferred embodiment, the upper layer will have a thickness of between 10 mm and 20 mm.

The outer portion may extend around the entire periphery or alternatively, only along sides and/or ends depending on the particular configuration of the vehicle and the intended use.

In a particularly preferred embodiment, the outer softer portions are formed to have a smooth surface while the inner portion will have a textured or embossed surface to give the same a non slip character.

### BRIEF DESCRIPTION OF THE DRAWINGS

Having thus generally described the invention, reference will be made to the accompanying drawings illustrating an embodiment thereof, in which:

FIG. 1 is a perspective view illustrating a vehicle (in phantom lines) having a floor structure;

FIG. 2 is top plan view, partially in cut-away, of the floor structure of the vehicle of FIG. 1;

FIG. 3 is a cross sectional view taken along the lines 3-3 of FIG. 2;

FIG. 4 is a cross sectional view taken along the lines 4-4 of FIG. 2;

FIG. 5 is an enlarged view of the corner portion of the floor structure;

FIG. 6 is a perspective view of a tractor and trailer unit;

FIG. 7 is a top plan view, partially in cut-away, of the floor structure of the trailer of FIG. 6; and

FIG. 8 is cross sectional view taken along the lines 8-8 of FIG. 7.

### DESCRIPTION OF THE PREFERRED EMBODIMENTS

Referring to the drawings in greater detail and by reference characters thereto, there is illustrated in FIG. 1 a truck which is generally designated by reference numeral 10 and which has a floor structure generally designated by reference numeral 12.

Floor structure 12 comprises a plurality of transversely extending C-shaped frame members 14. Extending around the outer edge are provided inverted L-shaped frame members 16.

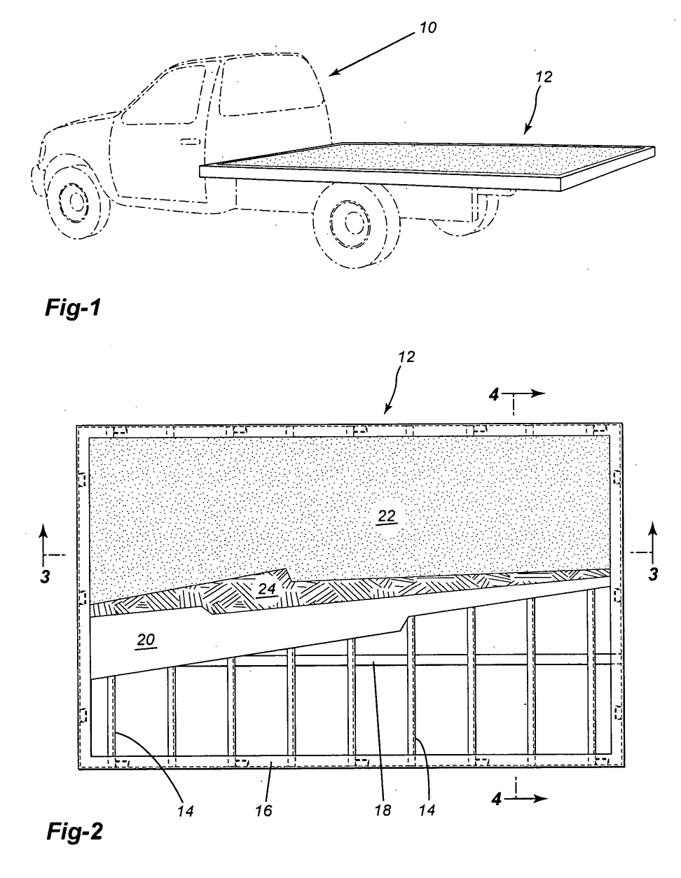

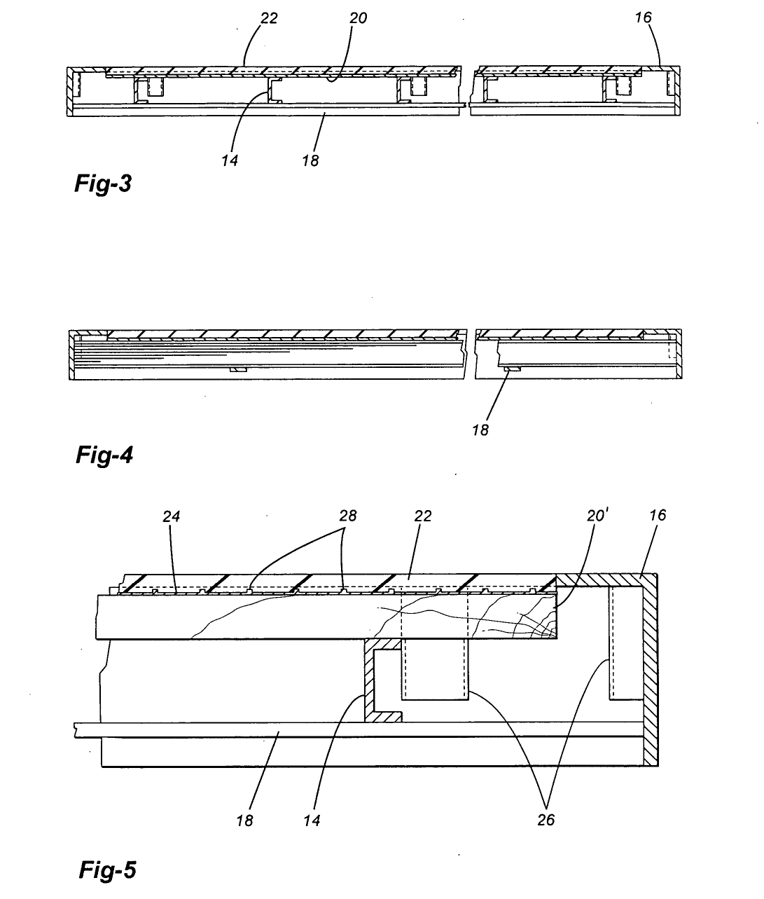

Mounted to the underside of inverted L-shaped frame members 16 is a floor structure 12 having a bottom layer 120 and a top layer 122. Bottom layer 20, in the illustrated embodiments of FIGS. 1 to 4, comprises a thin metallic layer either of stainless steel or aluminum and preferably having a thickness of at least 30 mm.

Top layer 22, which is of a composition as previously set forth hereinabove, is secured to bottom layer 20 by means of an adhesive layer 24.

In the embodiment of FIG. 5, there is provided a bottom layer 20′ which is formed of a hardwood material, preferably between 15 and 30 mm thick.

In this regard, layer 20′ can be formed of suitable composite materials and manufactured materials as desired.

In the bottom of rubber layer 22, there are provided a plurality of grooves 28.

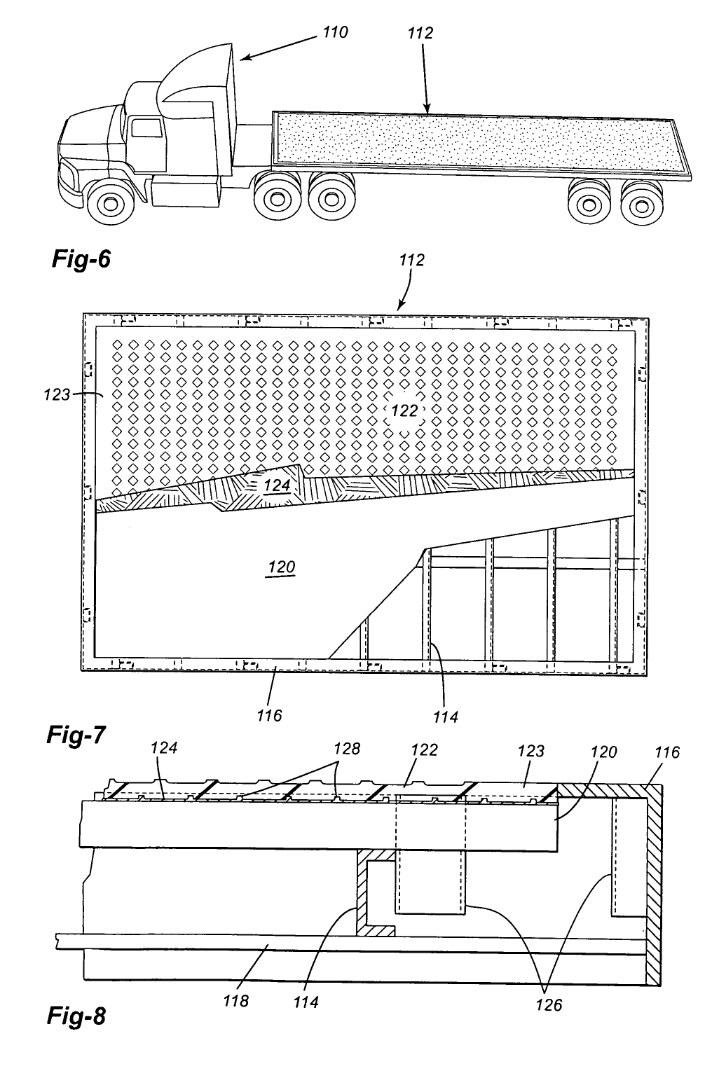

Turning to the embodiments illustrated in FIGS. 6 to 8, similar reference numerals in the 100's are employed for similar components.

In greater detail, there is illustrated a truck which is generally designated by reference numeral 10 and which has a floor structure 112 on a trailer unit. As previously described, floor structure 112 includes a plurality of transversely extending C-shaped frame members 114 with inverted L-shaped frame members 116 extending thereabout.

As may be seen in the drawings, floor structure 112 includes a bottom layer 120 and an inner top layer 122 secured by adhesive 124. Top layer 122 has an embossed surface while about the periphery of top layer 122, there is provided a second top layer 123 which has a lower hardness than central top layer 122. Moreover, peripheral top portion 123 has a smooth surface.

It will be understood that the above described embodiment is for purposes of illustration only and that changes and modifications may be made thereto without departing from the spirit and scope of the invention.

1. A flooring product suitable for use on a vehicle, the flooring product comprising:
a base formed of a load bearing material;
an upper layer formed of rubber fragments bonded together, said upper layer being secured to said base; and
said upper layer being formed of at least a first portion and a second portion, said first portion and said second portion each having a different hardness measurement.

2. The flooring product of claim 1 wherein said first portion comprises a central portion of said upper layer, said second portion being an outer portion at least partially located at a periphery of said upper layer.

3. The flooring product of claim 2 wherein said base is a sheet material selected from a group consisting of metallic sheet material and wood sheet material.

4. The flooring product of claim 3 wherein said base is a metallic material.

5. The flooring product of claim 4 wherein said metallic material is aluminum.

6. The flooring product of claim 3 wherein said sheet material is wood.

7. The flooring product of claim 6 wherein said wood comprises a laminated wood product.

8. The flooring product of claim 2 wherein said base comprises a sheet material of aluminum and laminated wood.

9. The flooring product of claim 7 wherein said laminated wood has a fiberglass coating on an underside thereof.

10. The flooring product of claim 2 wherein said central portion has a hardness of between A76 to A90.

11. The flooring product of claim 2 wherein said outer portion has a hardness of between A65 to A76.

12. The flooring product of claim 2 wherein said central portion has an embossed surface and said outer portion has a smooth surface.

13. The flooring product of claim 2 wherein said upper layer has a thickness of between 10 mm and 20 mm.

14. In a vehicle having a floor for receiving cargo, and wherein said floor is supported by structural members, the improvement wherein said floor comprises a lower layer and an upper layer, said lower layer being formed of a load bearing material selected from the group consisting of wood materials and metallic materials, said upper layer being adhesively secured to said lower layer, said upper layer being formed of rubber fragments bonded together.

15. The vehicle of claim 14 wherein said upper layer comprises a first portion and a second portion, said first portion and said second portion each having a different hardness measurement.

16. The vehicle of claim 15 wherein said first portion comprises a central portion of said upper layer, said second portion being an outer portion at least partially located at a periphery of said upper layer.
